(19) United States
(12) Patent Application Publication
(10) Pub. No.: US 2020/0234256 A1
(43) Pub. Date: Jul. 23, 2020

(54) Techniques to Link Transactions with Cryptocurrency Payments

(71) Applicant: Spera, Inc., Cedar Hills, UT (US)

(72) Inventors: Gregori Pesci, Cedar Hills, UT (US); Damon Hogan, Orem, UT (US)

(21) Appl. No.: 16/254,156

(22) Filed: Jan. 22, 2019

(51) Int. Cl. G06Q 20/06; G06Q 20/14; G06Q 20/38; G06Q 20/32

(52) U.S. Cl. CPC G06Q 20/065; G06Q 20/14; G06K 7/1417; G06Q 20/3276; G06Q 2220/00; G06Q 20/389

(57) ABSTRACT

Methods, systems, and devices for cryptocurrency transactions are described. An index value associated with a transaction for goods or services may be included in a block chain entry of a cryptocurrency transaction. The index value may be embedded in a field of information already present in the block chain entry. Upon receiving a cryptocurrency payment a transaction component may be configured to use the index value to link the transaction for goods or services with the cryptocurrency payment.

### BACKGROUND

The following relates generally to cryptocurrencies and, more specifically to techniques to link business transactions with cryptocurrency transactions. Cryptocurrencies represent a form of a distributed electronic monetary system. Cryptocurrencies may use cryptographic algorithms, such as a blockchain, to record transactions, control the creation of additional units, and to protect against fraud, such as double-spending. Many cryptocurrencies rely on a decentralized network of independent computers to collectively manage the currency, instead of a central governing authority. For many cryptocurrencies, every computer in the decentralized network may have a copy of the blockchain, or a ledger that records all of the transactions of the cryptocurrency. Transactions and linked to previous transactions in a manner that prevents fraudulent transfers of the cryptocurrency (e.g., double spending the same unit of cryptocurrency). For a transaction to be successful, independent computers of the decentralized network must verify the transfer.

Cryptocurrency payment systems may be operated independent of some business or purchasing systems. A user may desire to purchase goods or services using cryptocurrency through a purchasing platform.

### SUMMARY

A method of cryptocurrency transactions is described. The method may include generating, for a transaction for goods or services, a cryptocurrency transaction that includes a payment address associated with the cryptocurrency transaction and a block entry including at least one field of information associated with the transaction, modifying the at least one field of the cryptocurrency transaction to include an index value associated with the transaction and configured to link the transaction with the cryptocurrency transaction, and outputting the cryptocurrency transaction that includes the index value.

An apparatus for cryptocurrency transactions is described. The apparatus may include a processor, memory in electronic communication with the processor, and instructions stored in the memory. The instructions may be executable by the processor to cause the apparatus to generate, for a transaction for goods or services, a cryptocurrency transaction that includes a payment address associated with the cryptocurrency transaction and a block entry including at least one field of information associated with the transaction, modify the at least one field of the cryptocurrency transaction to include an index value associated with the transaction and configured to link the transaction with the cryptocurrency transaction, and output the cryptocurrency transaction that includes the index value.

Another apparatus for cryptocurrency transactions is described. The apparatus may include means for generating, for a transaction for goods or services, a cryptocurrency transaction that includes a payment address associated with the cryptocurrency transaction and a block entry including at least one field of information associated with the transaction, modifying the at least one field of the cryptocurrency transaction to include an index value associated with the transaction and configured to link the transaction with the cryptocurrency transaction, and outputting the cryptocurrency transaction that includes the index value.

A non-transitory computer-readable medium storing code for cryptocurrency transactions is described. The code may include instructions executable by a processor to generate, for a transaction for goods or services, a cryptocurrency transaction that includes a payment address associated with the cryptocurrency transaction and a block entry including at least one field of information associated with the transaction, modify the at least one field of the cryptocurrency transaction to include an index value associated with the transaction and configured to link the transaction with the cryptocurrency transaction, and output the cryptocurrency transaction that includes the index value.

Some examples of the method, apparatuses, and non-transitory computer-readable medium described herein may further include operations, features, means, or instructions for identifying a time stamp associated with a cryptocurrency payment received based on outputting the cryptocurrency transaction, identifying the index value included in the at least one field associated with the received cryptocurrency payment where the at least one field may be a blockchain entry, and verifying that the received cryptocurrency payment may be the cryptocurrency transaction associated with the transaction based on identifying the index value.

Some examples of the method, apparatuses, and non-transitory computer-readable medium described herein may further include operations, features, means, or instructions for outputting an indication that the cryptocurrency payment may be received based on verifying that the received cryptocurrency payment may be the cryptocurrency transaction.

Some examples of the method, apparatuses, and non-transitory computer-readable medium described herein may further include operations, features, means, or instructions for clearing an invoice associated with the transaction based on verifying that the received cryptocurrency payment may be the cryptocurrency transaction.

Some examples of the method, apparatuses, and non-transitory computer-readable medium described herein may further include operations, features, means, or instructions for confirming that the index value in the at least one field and the time stamp matches a time block associated with the generation of the index value, where verifying that the received cryptocurrency payment may be the cryptocurrency transaction may be based on the confirmation.

Some examples of the method, apparatuses, and non-transitory computer-readable medium described herein may further include operations, features, means, or instructions for identifying a time block associated with generating the cryptocurrency transaction, generating the index value based on identifying the time block associated with the cryptocurrency transaction, where modifying the cryptocurrency transaction may be based on generating the index value, and receiving a cryptocurrency payment associated with the index value based on outputting the cryptocurrency transaction.

Some examples of the method, apparatuses, and non-transitory computer-readable medium described herein may further include operations, features, means, or instructions for verifying that the received cryptocurrency payment may be the cryptocurrency transaction based on matching the index value associated with the time block with the index value in the received cryptocurrency payment.

Some examples of the method, apparatuses, and non-transitory computer-readable medium described herein may further include operations, features, means, or instructions for verifying that the received cryptocurrency payment may be the cryptocurrency transaction based on matching the index value of an earlier time block to the index value in the received cryptocurrency payment, matching the received cryptocurrency payment to the cryptocurrency transaction outputted during the earlier time block, or matching at least two fields of the received cryptocurrency payment to those of the cryptocurrency transaction of the earlier time block, or combinations thereof.

Some examples of the method, apparatuses, and non-transitory computer-readable medium described herein may further include operations, features, means, or instructions for identifying a time block associated with determining the index value, and determining the index value based on identifying the time block, where modifying the at least one field of the cryptocurrency transaction may be based on determining the index value.

In some examples of the method, apparatuses, and non-transitory computer-readable medium described herein, the time block may be associated with scanning a code posted when generating the transaction.

In some examples of the method, apparatuses, and non-transitory computer-readable medium described herein, the code includes a QR code.

In some examples of the method, apparatuses, and non-transitory computer-readable medium described herein, the code includes a first QR code that includes the payment address for the cryptocurrency transaction, and a second OR code that includes at least one transaction detail for the transaction.

In some examples of the method, apparatuses, and non-transitory computer-readable medium described herein, the at least one field of the cryptocurrency transaction indicates an amount of cryptocurrency exchanged, and the index value replaces one or more digits of the amount of cryptocurrency exchanged.

In some examples of the method, apparatuses, and non-transitory computer-readable medium described herein, the one or more digits replaced with the index value includes a satoshi amount digit of the amount of cryptocurrency exchanged.

Some examples of the method, apparatuses, and non-transitory computer-readable medium described herein may further include operations, features, means, or instructions for replacing at least one digit that indicates the amount of cryptocurrency exchanged with the index value, where modifying the at least one field of the cryptocurrency transaction may be based on replaying the at least one digit.

Some examples of the method, apparatuses, and non-transitory computer-readable medium described herein may further include operations, features, means, or instructions for outputting the cryptocurrency transaction includes outputting the cryptocurrency transaction over a text messaging system.

### BRIEF DESCRIPTION OF THE DRAWINGS

FIG. 1 illustrates an example of a system that supports techniques for linking business transactions with cryptocurrency transactions in accordance with aspects of the present disclosure.

FIG. 2 illustrates an example of a screen of a user device involved with a business transaction in accordance with aspects of the present disclosure.

FIG. 3 illustrates an example of a screen of a user device involved with a business transaction in accordance with aspects of the present disclosure.

FIG. 4 illustrates an example of data associated with a cryptocurrency transaction in accordance with aspects of the present disclosure.

FIG. 5A illustrates an example of a block chain entry of a cryptocurrency transaction in accordance with aspects of the present disclosure.

FIG. 5B illustrates an example of a block chain entry of a cryptocurrency transaction in accordance with aspects of the present disclosure.

FIG. 6 illustrates an example of a screen of a user device involved with a business transaction in accordance with aspects of the present disclosure.

FIG. 7 illustrates an example of a screen of a user device involved with a business transaction in accordance with aspects of the present disclosure.

FIG. 8 illustrates an example of a process flow in accordance with aspects of the present disclosure.

FIG. 9 shows a diagram of a system including a transaction component in accordance with aspects of the present disclosure.

FIG. 10 shows a block diagram of a transaction component in accordance with aspects of the present disclosure.

FIGS. 11 and 12 show flowcharts illustrating methods in accordance with aspects of the present disclosure.

### DETAILED DESCRIPTION

Cryptocurrency payment systems can communicate with systems operating in fiat currencies so that users can make purchases using cryptocurrency. A user with an online cryptocurrency account may instruct an online purchasing program to communicate with the cryptocurrency account to pay for the goods or services through the online purchasing program even though the online purchasing program generally operates in fiat currency. However, to link the transaction with the online purchasing program to the cryptocurrency transaction, the user is generally requested to manually input information about the user's cryptocurrency account. In some cases, the user may be requested to manually input information about the transaction or the service or product details exchanged in the transaction so that the transaction can be linked to the cryptocurrency transaction. The manual inputs from a user add time and increase a burden on the purchaser using the cryptocurrency and, in some cases, may cause the user to not complete the purchase. The present disclosure provides a technical solution to linking two transactions operating in two different types of systems. This technical solution provides for automatic identification and linking of a cryptocurrency payment in a block chain system with a purchase in a system that offers goods or services. Linking the cryptocurrency payment with the purchase transaction can indicate that the payment for the good or service is received allowing the purchase process to achieve to the fulfillment stage where the purchased product is shipped, the service is provided, or an invoice is cleared, or a combination thereof.

This technical solution can be achieved in an online purchasing program, a brick or mortar store, or another type of environment by the cryptocurrency payment program outputting a cryptocurrency transaction and associated code with a cryptocurrency payment address to the user. The cryptocurrency transaction may include multiple fields. At least one of these fields may include a price of the goods or services in the cryptocurrency. In some cases, the price of the goods or services is originally determined in fiat currency and then is converted to a cryptocurrency amount. In other cases, the price of the goods or services may be originally calculated in cryptocurrency.

At least one of the fields in the cryptocurrency transaction may include an index value configured to identify the goods or services being purchased by the cryptocurrency payment. The index value may be generated based on time period when the cryptocurrency transaction is generated. In some examples, the index value is integrated with the cryptocurrency amount in the block chain entry of the cryptocurrency payment. In such examples, a quantity of digits that represent at least part of the cryptocurrency price may be modified to include the index value. As a result, the outputted cryptocurrency price in the cryptocurrency transaction may not precisely correlate to the fiat price for the goods or services. For example, the fiat price may be converted to an initial true conversion amount in the cryptocurrency. Then, the initial true conversion amount in the cryptocurrency may be adjusted so that at least one of the digits of data that represent the cryptocurrency amount reflect the index value. In some cases, the index value may replace the last one or more digits in the cryptocurrency amount field of a blockchain transaction.

In some cases, incorporating the index value into the cryptocurrency may not change the amount of fiat money paid by the cryptocurrency user. The cryptocurrency currency amount for different cryptocurrencies may go out a certain number of digits after the decimal point. For example, an amount value for a cryptocurrency transaction may go out eight digits after the decimal point. The minimum transferable amount of cryptocurrency may be referred to as a satoshi amount. In a specific example, the index value may replace the last two digits of an amount of cryptocurrency (e.g., the seventh and eighth digit from the decimal place) resulting in a technically different amount of fiat currency, but closely reflecting the initial true fiat currency amount. In some cases, this difference between the outputted cryptocurrency price and the true conversion amount maybe within a few cents or may be less than cent based on current exchange rate between the cryptocurrency and the fiat currency. The user of the cryptocurrency account initiates the payment of the modified cryptocurrency amount so that the cryptocurrency is transferred to the payment address. In this type of example, the index value in the cryptocurrency price can be used to identify the transaction after the payment is received at the payment address. With the index value in the cryptocurrency payment, the transaction involving the goods and/or services can be automatically linked without the assistance of the user.

Aspects of the disclosure are described in the context of a system and a transaction component. Aspects of the disclosure are further illustrated by and described with reference to an apparatus diagram and flowcharts that relate to techniques for linking business transactions with cryptocurrency transactions.

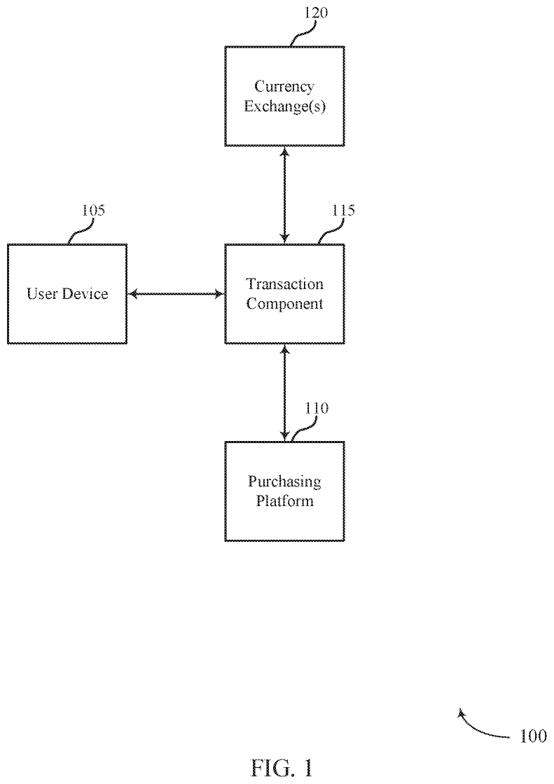

FIG. 1 illustrates an example of a system 100 that supports techniques for linking business transactions with cryptocurrency transactions in accordance with various aspects of the present disclosure. A user device 105 may be in communication with a purchasing platform 110. In some cases, the user that operates the user device 105 is a purchaser that accesses the purchasing platform. In some cases, the user device may be a mobile device, a phone, a laptop, a desktop, a scanner, a digital personal assistant, an electronic tablet, a networked device, an electronic device, another type of device, or combinations thereof. In some cases, the purchasing platform may include an online purchasing site, an electronic system that supports purchases of a brick and mortar store, a payment address, an electronic purchasing environment, another type of platform, or combinations thereof.

The transaction component 115 may facilitate at least part of the transaction between the user device 105, the purchasing platform 110, the currency exchanges 120, or a combination thereof. In some examples, the transaction component 115 may communicate with the user through a user interface of the user device, convert the fiat amount listed in the purchasing platform to the initial conversion amount in the cryptocurrency by communicating with the currency exchange 120, modify the cryptocurrency block chain entry to include the index value, receiving the payment made in the cryptocurrency including identifying the block chain entry associated with the cryptocurrency payment, track the index value associated with the transactions between the user device 105 and the purchasing platform 110, link the transaction between the user device 105 and the purchasing platform 110 with the cryptocurrency payment received over a currency exchange 120 based at least in part on the index value, organize work flows involved in the transaction, organize and prioritize to-do items, manage invoices, and receive and/or make payments, perform another operation associated with transactions between fiat currencies and cryptocurrency, or combinations thereof. In some cases, the transaction component 115 may exchange fiat currencies for cryptocurrencies, exchange cryptocurrencies for fiat currencies, and/or exchange a cryptocurrency for a different cryptocurrency.

The transaction component 115 may be an application configured to be executed or run by one or more devices (e.g., personal computing devices and/or core entities). The transaction component 115 may include one or more application programming interfaces (APIs) for interacting with other programs. For example, the transaction component 115 may include a cryptocurrency API for communicating with a currency exchange 120 for cryptocurrencies and/or an algorithm (e.g., blockchain) of a cryptocurrency directly. In some cases, the APIs may allow the transaction component 115 to monitor the cryptocurrency wallets associated with the merchant or associated with the user. In some cases, the transaction component 115 may be configured to issue cryptocurrency wallets to users to facilitate cryptocurrency transactions.

Cryptocurrencies may be used as an easy or inexpensive way to pay for goods and/or services where the payment crosses international boundaries, among other situations. If a user and the purchasing platform wish to have the option of using cryptocurrency for transactions, the user and the purchasing platform may sign up for one or more exchanges, digital wallets, or dashboards that allow users to buy and sell cryptocurrencies or use their existing accounts. Many of the existing exchanges of cryptocurrencies may be difficult to sign up for and may be difficult to use. Such difficulties in user experiences may prevent some potential users and platforms from using cryptocurrencies as a medium of exchange to pay for goods and/or services.

A fiat currency may be an example of currency that a government has declared to be legal tender. In some cases, a fiat currency may be not backed by a physical commodity. Examples of fiat currencies may include the United States dollar, the Euro, the British pound, the Japanese Yen, the Swiss franc, the Canadian dollar, the South Korean won, the Chinese Renminbi, and others. A fiat currency exchange may be a process or entity used to exchange fiat currency for goods or services. Examples of currency exchanges 120 for fiat currency may include credit card payments, automated clearing house payments, wire transfers, propay systems, debit card transactions, or other forms of processing payments.

A cryptocurrency may be an example of a medium of exchange that is not backed by a central authority, such as a government. A cryptocurrency may be a digital asset that may use cryptography to record transactions, control the creation of additional units, and to protect against fraud (e.g., double spending). In some cases, a cryptocurrency may be controlled by a decentralized network of peer computers. The cryptographic algorithms of the cryptocurrency may rely on distributed ledgers (such as a blockchain) to record transactions and to prevent fraud. To maintain the integrity of the cryptocurrency and/or to prevent fraud such as double spending of a single unit, the cryptographic algorithms may rely on a plurality of independent computers to validate and record transactions on the ledger (e.g., a blockchain). In theory, the self-interest of each of the independent computers (sometimes referred to as miners) maintain the security of the ledger. Examples of cryptocurrencies include Bitcoin, Ethereum, Ripple, Litecoin, Dash, NEM, Ethereum Classic, Monero, Zcash, Decred, PIVX, Bitcoin Cash, Cardano, NEO, Stellar, IOTA, EOS, TRON, Bitcoin Gold, Qtum, ICON, Lisk, RaiBlocks, Ardor, OmiseGo, other altcoin, or a combination thereof.

A currency exchange 120 for cryptocurrencies may be a process or an entity used to exchange cryptocurrency for goods and/or services, other cryptocurrencies, and/or fiat currency. Cryptocurrency exchanges may be configured as trading platforms, direct trading, brokers, or a combination thereof. Trading platforms may be exchanges that connect buyers and sellers and take a fee from each transaction. Direct trading platforms may offer direct person-to-person trading where each seller sets their own fees and/or rates for an exchange. Brokers may be platforms that can purchase or sell a cryptocurrency at a price set by the broker. Examples of the currency exchanges 120 for cryptocurrencies may include Coinbase, Kraken, Cex.io, ShapeShift, Poloniex, Bitstamp, CoinMama, Bitsquare, Gemini, other exchange, or a combination thereof.

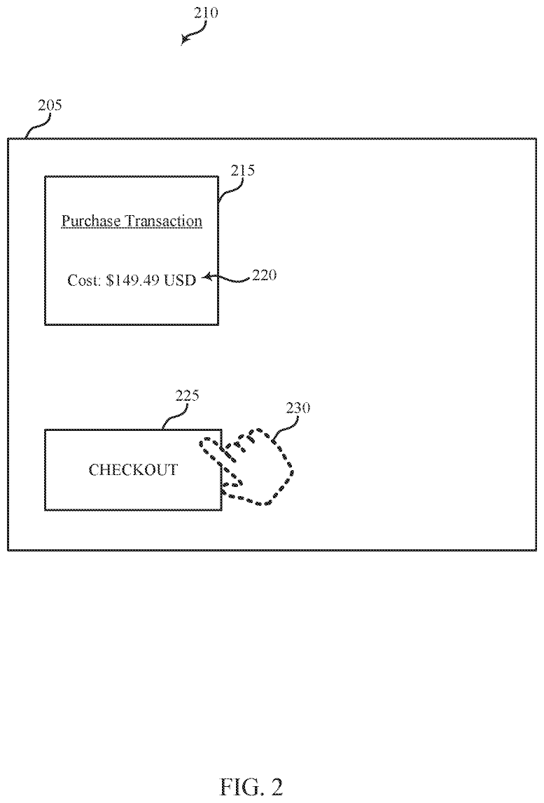

FIG. 2 illustrates an example of a user interface 205 of the user device 210. In this example, the user device 210 is in communication with a purchasing platform. Such a purchasing platform may be the purchasing platform of FIG. 1. In this example, the purchasing platform may cause the purchase transaction 215 to be displayed in the user interface 205 with a fiat currency price 220 of $149.49 U.S. dollars. If the user wishes to proceed with the purchase transaction, the user may initiate the purchase by checking out or giving another command to proceed with the purchase transaction using a fiat currency. In some examples, the user may proceed by selecting the checkout button 225 with a movable icon 230 in the user interface 205. In response to giving the command to proceed, the user interface 205 may communicate with a transaction component, such as the transaction component of FIG. 1 or another type of transaction component.

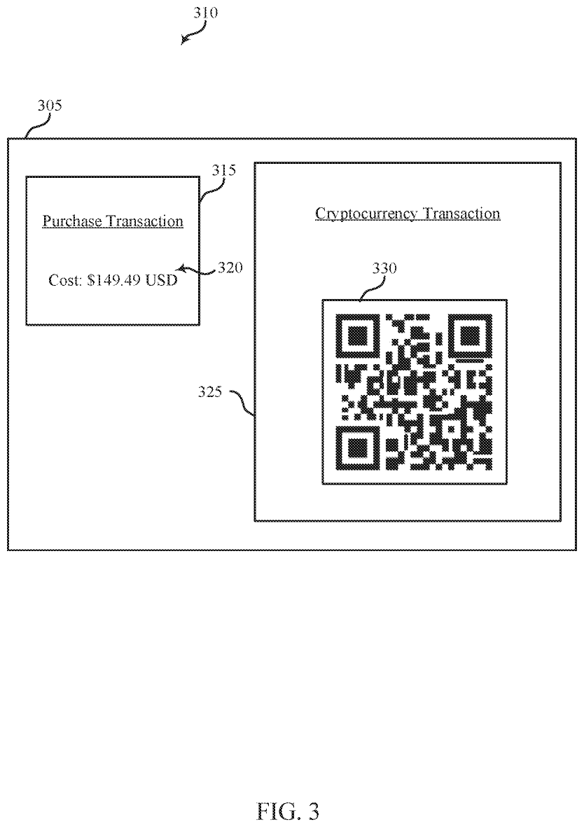

FIG. 3 illustrates an example of a user interface 305 of the user device 310, such as the user interface 205 of FIG. 2 or another type of user interface. In this example, the user device 310 is in communication with a purchasing platform. Such a purchasing platform may be the purchasing platform of FIG. 1. In this example, the user device 310 may be in communication with both the purchasing platform and a transaction component, such as the transaction component of claim FIG. 1 or another type of transaction component. In this example, the purchase transaction 315 and the fiat currency price 320 may be displayed to the user interface, but in other examples, at least one of these items may be removed from the display of the user interface 305.

The user interface 305 is depicted as showing a code 330 and a cryptocurrency transaction indication 325. In this example, the code 330 includes any desirable information that may be associated with the cryptocurrency transaction. For example, the code may contain information that includes a payment address, product details, shipping address, transaction number, time stamp, another type of detail, or combinations thereof. In some examples, multiple codes may be outputted to the user interface 305 that represent different types of information. The code 330 may be configured such that a camera or other scanner can capture an image of the code 330 and initiate a cryptocurrency payment through one of the cryptocurrency exchanges.

Any appropriate type of code may be used. In the example depicted in FIG. 3, the code 330 is a matrix code (e.g., a quick response (QR) code). In other examples, the code may include barcodes, Universal Product Code (UPC), International Article Number codes (also known as European Article Number (EAN) codes), code 30 barcodes, code 128 barcodes, interleaved barcodes, code 93 barcodes, Codabar barcodes, GS1 DataBar barcodes, modified plessey (MSI) barcodes, datamatrix codes, PDF417 codes, Aztec codes, colored codes, high capacity color codes, intercodes, Han Xin barcodes, cybercodes, shotcodes, snapcodes, scannable codes, other types of one-dimensional codes, other types of two-dimensional codes, other types of codes, or combinations thereof. In some examples, the code 330 may be an example of text message information enterable by the user to allow the user to transfer the cryptocurrency using one or more text messages.

The cryptocurrency transaction indication 325 may be modified to include an index value. In this example, the cryptocurrency payment amount outputted may be 0.0370025. In such an example, the last two digits of the cryptocurrency amount (e.g., digits “2” and “5”) may be the index value. For the illustrative cryptocurrency, the cryptocurrency is displayed with eight digits after the decimal place.

In this particular example, the index value replaces the last two digits in the outputted cryptocurrency payment amount. At least some cryptocurrencies include a satoshi digit, which is the smallest amount of cryptocurrency that can be exchanged in one transaction or that can be modified (e.g., in this specific example the satoshi amount is 0.00000001). For some cryptocurrencies, such as Bitcoin, the eighth digit after the decimal place is the satoshi digit. However, other currencies may include a different satoshi digit. For the purposes of this disclosure, the satoshi amount may be the appropriate satoshi amount used by the particular cryptocurrency, which may change if the satoshi digit of the cryptocurrency changes over time. In some examples, at least one of the digits replaced with the index value is the satoshi digit. In those examples where the index value includes multiple digits, the satoshi digit and another digit may be modified to include the index value. In some embodiments, the digits replaced with the index value are adjacent to each other with no intervening digits between them. In other examples, the index value may replace digits in the cryptocurrency payment amount at digits that have intervening digits between them. In the current example, the index value has two digits and the seventh and eight digits are paired together and replaced by the index value. In this example, the last two digits that can be modified in the cryptocurrency are paired together to be replaced by the index value and referred to as the satoshi amount.

While this description has referred to the index value including a single digit or two digits, the index value may include any appropriate number of digits. For example, the index value may include three, four, five, six, seven, eight, or more digits.

The user may scan the code 330 when the user desires to complete the transaction. Scanning the code 330 may cause a cryptocurrency payment to be made via a cryptocurrency exchange and the cryptocurrency to be sent to the payment address, which may be presented in the information in the code 330. Scanning the code may also result in the transaction component recording information about the transaction.

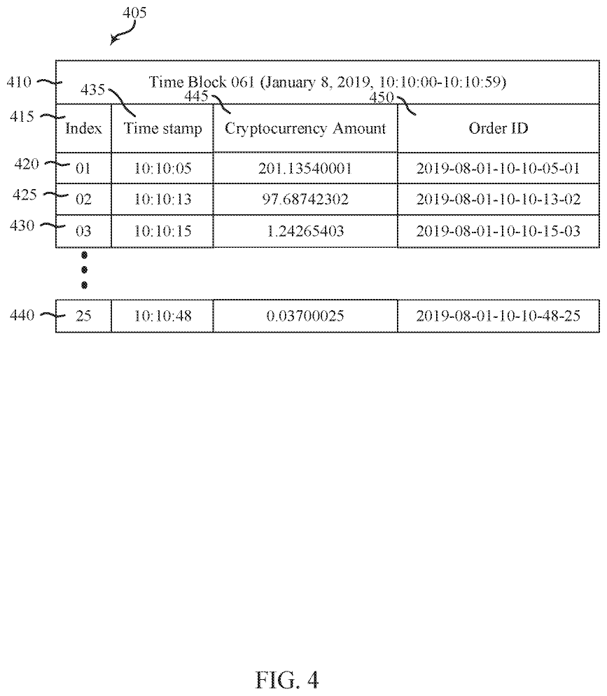

FIG. 4 illustrates an example of information that may be tracked by a transaction component, such as the transaction component of FIG. 1. In this example, the transaction component may organize the transactions and other types of information based on time blocks 405. A time block may be any duration of time during which index values are assigned. For example, the first index value assigned during a first time block may be 01. Because the number of digits available to be used for an index value in a block chain entry is limited, time blocks may be used as a way to reuse index values in different time blocks and expand their functionality. For example, during a first time block the index value 24 may be assigned to a first transaction, but during a second time block the index value 24 may be assigned to a second transaction. A time block 405 may be any duration of time. In this example, a time block 405 represents one minute spanning from 10:10:00 to the 10:10:59. However. the time block 405 may represent one second, a portion of a second, more than one second, multiple seconds, a minute, a portion of a minute, more than one minute, multiple minutes, a portion of an hour, an hour, more than an hour, multiple hours, another time period, or combinations thereof.

Within each time block, the transaction component may sequentially list each of the transactions for a particular cryptocurrency assigning each transaction an index value 415. For example, the first transaction 420 to occur within the cryptocurrency in the time block 405 may receive an index value 415 of 01. The second transaction 425 to occur within the cryptocurrency in the time block 405 may receive an incremented index value 415 of 02. The third transaction 430 in the time block may receive an index value 415 of 03 and so forth. The index values 415 may be assigned based on the time stamps 435 associated with the transaction (e.g., time when the transaction or cryptocurrency transaction are generated).

The index value 415 assigned to the transaction (or cryptocurrency transaction) may be the same index value that replaces the designated digits in the cryptocurrency payment amount. In the example of FIG. 3, the cryptocurrency payment amount is 0.0370025 and last two digits in the cryptocurrency payment amount are replaced with the index value (e.g., “25”). Thus, the transaction 440 associated with the index value of 25 depicted in FIG. 4 is associated with the transaction depicted in FIG. 3.

The event that causes the time stamp 435 to be recorded may be any appropriate event associated with the cryptocurrency transaction. In some examples, the time stamp 435 occurs when the code displayed in the user device is scanned. The transfer of the cryptocurrency may be triggered when the code is scanned. In other examples, the time stamp 435 may reflect when the cryptocurrency payment amount is initially outputted to the display of the user device. In some cases, the time stamp 435 is recorded when the cryptocurrency transaction is generated. In some cases, the time stamp 435 is recorded when the business transaction is generated. In some cases, the time stamp 435 is recorded at the transition from a first time block to a second time block. In some cases, a different event may trigger the recordation of the time stamp 435.

In some cases, the time stamp 435 is recorded at the transition from a first time block to a second time block. For example, if three transactions (e.g., business transactions or cryptocurrency transactions) from the first time block are still pending when the second time block starts, the transactions may be reassigned index values for the second time block. This way transactions may keep rolling over between time blocks. This situation may prompt the cryptocurrency payment amount 445 to be updated again to reflect a different index value associated with the second time block. In another type of situation, the cryptocurrency payment amount 445 may be outputted to the user interface long enough that the time block expires, which may also trigger an update to the index value 415. In some cases, the cryptocurrency payment amount 445 may be modified multiple times based on how many time blocks 410 expire and how many other cryptocurrency transaction by other users occur before the user scans the code. In some cases, the code may also be updated to reflect the most recent information based on the number of other orders completed by other users and the expiration of the time blocks. Each time the index value (e.g., the cryptocurrency amount) is updated, a new code 330 or new information may be output to the user.

The transaction component may also record the cryptocurrency payment amount 445 and an order identification number 450. The order identification number 450 can be any appropriate identification number associated with the business transaction or cryptocurrency transaction. In the depicted example, the order identification number 450 reflects a combination of the time stamp 435 and the index value 415. In this example, the first sequence of numbers in the order identification number 450 represents the information in the time stamp 435 and the second sequence of numbers represents the index value 415.

While this disclosure describes specific types of information that may be tracked by the transaction component, the transaction component may track additional information. For example, the transaction component may also track product details, service details, account information, internet protocol (IP) addresses, locations of sales, purchasing party information, selling party information, payment address information, shipping address information, other shipping information, personal contact information, other types of information, or combinations thereof. The information tracked by the transaction component may be accessible to the purchasing platform. In some cases, the information tracked by the transaction component may also be accessible to the user, a third party, or combinations thereof.

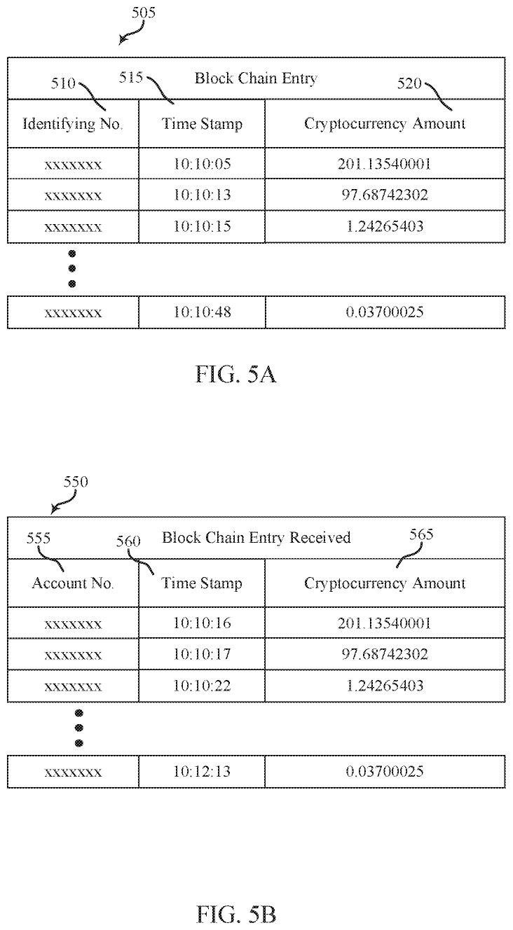

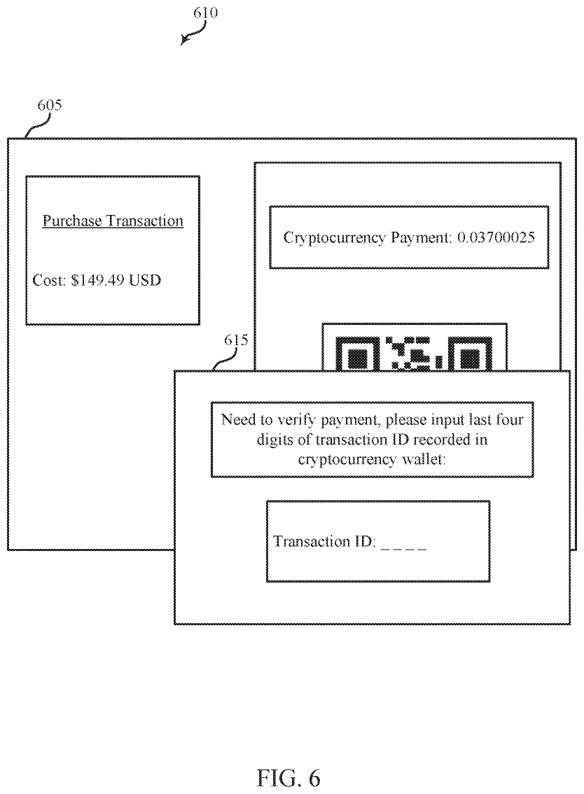

FIG. 5A illustrates an example of a block chain entry 505. The block chain entry 505 may include an identifying number 510, a time stamp 515, and a received cryptocurrency payment amount 520. In some cases, the block chain entry 505 includes all the information that is tracked by a transaction component, such as the transaction component described in conjunction with FIGS. 1-4. In other examples, the block chain entry 505 may contain just a subset of the information that is tracked by the transaction component.

In this example, the time stamp 515 may record when the cryptocurrency payment is received or when the cryptocurrency payment is added to the block chain. The time stamp 435 depicted in FIG. 4 and the time stamp 515 depicted in FIG. 5 may be different. However, in some situations, depending on the latency between when the code is scanned and the cryptocurrency payment is received, time stamp 435 and the time stamp 515 may be the same.

The information in the block chain entry 505 may be used to link the cryptocurrency payment received to the transaction. In some cases, the receiving party may receive a cryptocurrency payment without knowing what the cryptocurrency payment is for. The block chain entry 505 may be configured to allow the purchasing platform, transaction component, or other entity to link the cryptocurrency payment with the transaction. For example, with just the time stamp 515 and the cryptocurrency payment amount 520, the user can locate the transaction in the data stored by the transaction component. For example, the transaction component can reference the time stamp 515 to determine the time block during which the transaction likely took place. Even though the time stamp 515 may be different than the time stamp recorded by the transaction component, the time stamp 515 may be close enough to identify the correct time block on which the cryptocurrency transaction is recorded by the transaction component. In some cases, the transaction component may be configured to identify one or more candidate time blocks based on the time stamp 515 and then use other information to further identify the time block from the one or more candidate time blocks.

The transaction component may identify the value of the digits that should include the index value. In some cases, the index value may be embedded in the cryptocurrency amount. The transaction amount may identify the transaction associated with the cryptocurrency payment using the time stamp 515 and the index value. In some cases, the transaction component may also use the cryptocurrency amount to verify that the cryptocurrency payment is associated with the transaction. If the index value in the cryptocurrency payment is represented consistently by the same digits in the cryptocurrency payment, the transaction component may determine the index value by identifying the values of the predetermined digits. Thus, by referencing the index value of the received cryptocurrency payment, the cryptocurrency transaction in the time block can be identified. Consequently, the transaction recorded by the transaction component and the cryptocurrency transaction can be linked. Linking the transactions can verify to the purchasing platform that the payment has been received allowing the purchasing platform to move to fulfillment of the purchase.

To ensure accuracy, the transaction component may compare the received cryptocurrency payment amount 520 with the cryptocurrency amount associated with the time block. If the amounts match, the transaction component may verify that the cryptocurrency transaction is complete and/or link the transactions to each other. In some embodiments, the transaction component may compare other information between that which is recorded in the block chain entry 505 and that which is recorded in the time block in additional to comparing the payment amounts or in lieu of comparing the payment amounts.

FIG. 5B illustrates an example of a block chain entry 550. The block chain entry 550 may include an identifying number 555, a time stamp 560, and a received cryptocurrency payment amount 565. The block chain entry 550 may depict the situation where the where the block chain entry is identified in a first time block, but the index value is associated with a second time block different than the first time block. Assuming that the other time blocks are recorded in periodic increments, the time stamp 560 may include a time that is associated with a different time block than the index value in the cryptocurrency payment amount 565. In a situation where the time stamp 560 is associated with a different time block, the combination of the time stamp 560 and the index value in the cryptocurrency payment amount 565 may direct the transaction component to a transaction that is not associated with the cryptocurrency payment. In this situation, when the transaction component compares the payment amounts or other information in the block chain entry 550 to that recorded in the time block, the transaction component may find a mismatch.

In response to finding a mismatch, the transaction component may take any appropriate response. In some cases, the response may include searching a number of the preceding time blocks. For example, if a mismatch occurs, the response may include examining the index values of at least one preceding time block to determine whether the index value in the received cryptocurrency payment amount 565 and the cryptocurrency payment amount 565 match the information associated with the time block. If a match is found, the transaction component may verify that the transaction is complete and/or link the transactions. If the index value in the preceding time blocks fail to provide a match, the transaction component may compare each of the other payment amounts in the same time block for a payment match. If the match is found, the transactions may be linked and/or verified. In the situation where the preceding time block fails to identify a match, the next preceding time block may be analyzed in at least a similar fashion. This process may be repeated until a predetermined number of time blocks are searched. In some embodiments, just those transactions with the same index value are analyzed for the match in the preceding time blocks. In yet other examples, just those transactions with the same index value are initially analyzed before broadening the search to include transactions with different index values.

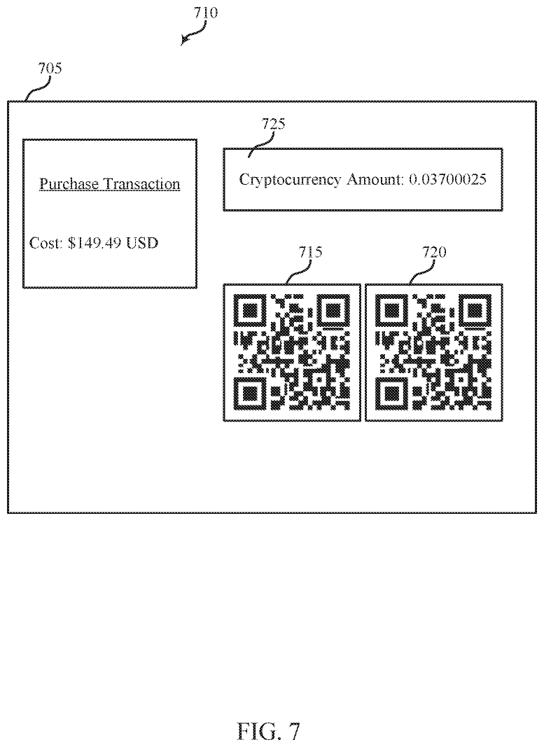

FIG. 6 illustrates an example of a user interface 605 of the user device 610, such as the user interface 305 of FIG. 3 or another type of user interface. In situations where the transaction component is not able to link the transaction with a cryptocurrency payment, the transaction component may use manual techniques link a cryptocurrency payment with the transaction. In this example, the user device 610 may depict a prompt 615 requesting additional information from the user. This information may include at least some of the digits of the transaction identification number, information about the user's cryptocurrency account, the cryptocurrency payment amount, product details, service details, other types of information, or combinations thereof. The prompt may be used to assist the transaction component in linking the business transaction with the cryptocurrency transaction. The additional information may be requested by the transaction component. In some cases, the receiving party may request the additional information from the transaction component. The transaction component may request that the user manually input the requested information.

In some cases, a mismatch may occur between the block chain entry and the information stored in the time block. The mismatches may occur when the user's cryptocurrency amount does not have funds to cover the entire cryptocurrency payment amount, when an issue occurs and the exact cryptocurrency amount is not paid, another type of issue, or combinations thereof. In some cases where the exact amount of the cryptocurrency is not paid, a perfect match may not be found between the block chain entry and the information stored by the transaction component in the time blocks. In this type of situation, the transaction component may still link the cryptocurrency transaction with the business transaction by matching up at least some of the data from the block chain entry and the information tracked by the transaction component. For example, if the time stamps match, but the actual cryptocurrency amount paid does not exactly match the cryptocurrency transaction price stored by the transaction component, the transaction component may determine whether the difference between the two amounts satisfies a threshold. If the difference between the amounts do not satisfy the threshold, the transaction component may conclude that the transactions are to be linked. If the difference between the amounts do satisfy the threshold, the transaction component may conclude that the transactions should not be linked and that additional verification procedures may be initiated to verify a linking between a cryptocurrency payment and a transaction. Examples of additional verification procedures may include examining other time blocks, prompting the user for additional information, or combinations thereof. Factors that the transaction component may weight when determining whether to link the amounts may include the differences between times represented by the time stamps, differences between the index values, the differences between transaction amounts, differences between account numbers, the number of other cryptocurrency transactions that are not linked to other business transactions, the weighted score of other transactions that could be linked to the cryptocurrency transaction, other factors, or combinations thereof.

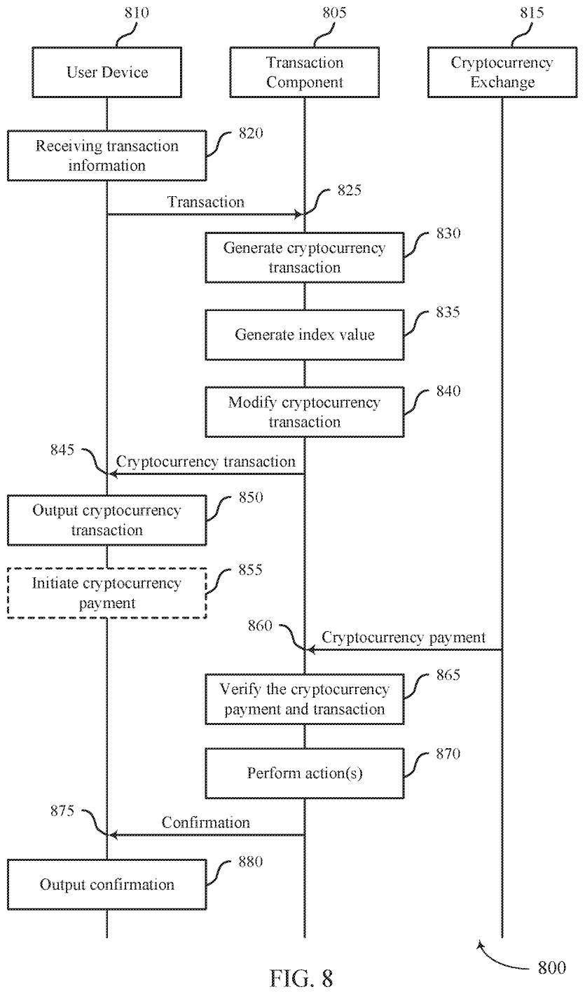

FIG. 7 illustrates an example of a user interface 705 of the user device 710, such as the user interface 305 of FIG. 3 or another type of user interface. In this example, the user device 710 depicts a first code 715 and a second code 720 that is outputted to the user interface 705 with the cryptocurrency payment amount 725.

The first code 715 may include a first set of information, and the second code 720 may include a second set of information. In some examples, the first set and second set of information have different types of information that do not overlap. In other examples, at least a portion of the information in the first and second sets of information overlap. At least a portion of the information that is stored in the codes may be tracked by the transaction component, be included in the block chain entry, be stored by another component, or combinations thereof. In one example, at least one of the first code and the second code stores product or service information while the other code includes a cryptocurrency payment address. Types of information that may be stored in either, both, and/or portions thereof may include payment addresses, fiat amounts, shipping addresses, tracked shipping information, cryptocurrency amounts, product details, service details, other type of information, or combinations thereof. While these examples have been described with two different codes, any appropriate number of codes may be outputted to the user interface 705 and be associated with the outputted cryptocurrency payment amount. In some examples, the first code 715 may include information related to the transaction, including the cryptocurrency payment amount and the second code 720 may include the payment address.

In some examples when the cryptocurrency payment amount may be outputted to the user device, the cryptocurrency payment is outputted with a text messaging system. In some cases, the cryptocurrency payment is outputted into multiple formats to give the user an option on which type of program to use to pay the cryptocurrency payment. In those situations that the user instructs that the cryptocurrency payment be made through the text messaging system, the messaging number (e.g. phone number) of the user device may be tracked by the transaction component. In some cases, the messaging number of the user device may be included in the block chain entry. The messaging number may be used to assist with linking the business transaction and the cryptocurrency transaction.

As an example, the user may sign up for a cryptocurrency account that operates at least in part by text messaging. When the user selects to checkout of the online purchasing program, the transaction component may generate a cryptocurrency amount for the transaction. The user may text the information output to the user interface to the number indicated to initiate the cryptocurrency transaction. In some cases, the user may enter the messaging number to receive a text message containing the cryptocurrency transaction so that the transaction can be sent to the device with the messaging number. In some cases, the transaction component may know or detect the number of the mobile device and automatically send a text containing the transaction to the mobile device without requesting the number from the user.

In some cases, the information communicated with the user over text messaging is a single text. In other examples, multiple texts are communicated with the user through the text message program. In some examples where multiple texts are communicated with the device with the messaging number, at least one of the text messages may be dedicated to sending the cryptocurrency payment address. Information that may be sent in the text message(s) through the user may include the cryptocurrency payment address, satoshi amount, fiat currency, index value, cryptocurrency payment amount, product details, service details, shipping address, shipment tracking details, other types of information, or combinations thereof. The transaction component may associate the messaging number with the transaction. With the information sent to the user device about the cryptocurrency, the user may instruct that the cryptocurrency payment be made through the text messaging system.

The user may receive a confirmation text indicating that the transaction was completed to the same device that has the messaging number from which the payment instructions were made. The chain block entry and time block information may be used to link the business transaction with the cryptocurrency transaction.

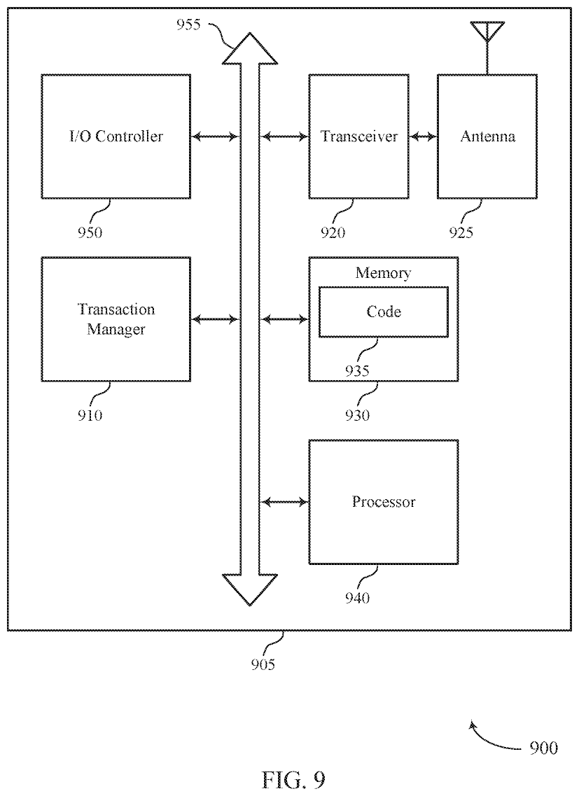

FIG. 8 illustrates an example of a process flow 800 for linking business transactions and cryptocurrency payments in accordance with aspects of the present disclosure. The process flow 800 shows aspects of the features and processes described above with reference to FIGS. 1-7. The features of the process flow may be combined with aspects described in FIGS. 1-7. The process flow 800 shows communications between and procedures performed by a transaction component 805, a user device 810, and a cryptocurrency exchange 815. The transaction component 805 may be an example of a transaction component 805 described with reference to FIGS. 1-7, including the transaction component 115. The user device 810 may be an example of user device 105 described with reference to FIG. 1. The cryptocurrency exchange 815 may be an example of a currency exchange 120 described with reference to FIG. 1.

At block 820, the user device 810 may receive transaction information from a user. The transaction information may be received as part of purchasing platform, such as for online commerce. For example, a user may shop for good or service using the user device 810 and may select a good or service and/or features of the good or service. The transaction information may include any information about the good or service being sought. For example, the transaction information may include the type of good or service being provided, features of the good or service (e.g., color, size, make, model, basic, premium, etc.), the price of the good or service, the quantity of the goods or services, or combinations thereof. In some cases, the transaction information may be input as an invoice for a good or service already provided.

In some cases, the user, via the user device 810, may indicate that the user would like to pay for the good or service using a cryptocurrency. In some cases, the transaction information 825 may include an indication that user would like to pay using a cryptocurrency. In some cases, the indication may include an indication of the type of cryptocurrency desired to be used by the user.

The user device 810 may transmit the transaction information 825 to the transaction component 805. The transaction information 825 may be communicated over any communication network, including a wired network, a wireless network, or a combination thereof. The transaction information 825 may be communicated in real-time or may be sent periodically.

At block 830, the transaction component 805 may generate a cryptocurrency transaction based on the transaction information 825. The transaction component 805 may generate the cryptocurrency transaction based on the transaction information 825 including an indication that the user would like to pay with cryptocurrency. In some cases, the transaction component 805 may generate the cryptocurrency transaction automatically. Generating the cryptocurrency transaction may include identifying a cryptocurrency amount for the good or service. In some cases, this may include converting a fiat currency amount for the good or service to a cryptocurrency amount. In some cases, the transaction component 805 may generate the cryptocurrency amount directly. The transaction component 805 may also identify a payment address for the cryptocurrency transaction. In some cases, the transaction component 805 select a payment address from a plurality of payment address associated with the merchant or vendor. The transaction component 805 may identify a type of cryptocurrency to be used for the cryptocurrency transaction and generate the cryptocurrency transaction accordingly.

At block 835, the transaction component 805 may generate an index value configured to link the transaction with the cryptocurrency transaction. The index value may be included in information that may be included as part of a block chain entry. As such, the index value may be configured to replace other information that is already present in a block chain entry. For example, one or more digits of the cryptocurrency amount may be replaced by the index value. By embedding the index value in the block chain entry, the transaction component may be configured to identify a cryptocurrency payment when it is received and link it to its associated transaction for a good or service.

Cryptocurrency payment options and purchasing platforms may not always be the same integrated system. For example, a purchasing platform may allow users to select goods and services for purchase. These purchasing platforms may traditionally allow users to pay using a fiat currency. In contrast, payment using cryptocurrencies may be performed by third-party cryptocurrency exchanges. Because the entity providing the goods or services and the entity processing the cryptocurrency payment are different, this may create a situation where it may be difficult to correlate a transaction on the purchasing platform with received cryptocurrency payment. The index value is a unique identifier embedded in the block chain that allows the transaction component to correlate or link a received cryptocurrency payment with a transaction on a purchasing platform with minimal intervention by the user or other humans.

The index value may be any number of digits. In some examples, the index value may be two digits. The index value may be incorporated into the least significant digits of a cryptocurrency amount. Based on the exchange rate between a cryptocurrency and a fiat currency, altering the least significant digits of a cryptocurrency amount may have a negligible or non-existent impact on the amount of fiat currency being exchanged.

The index value may be generated based on different time blocks to increase the number of index values available for use. Because the index value may replace some information in the block chain entry, the size of the index value may be limited so as to minimize or reduce the impact on the information being removed to make room for the index value. For example, if the index value replaces digits of the cryptocurrency amount, it may be important to make sure that the index value does not impact too much the amount of money being exchanged (whether fiat or crypto). If the index value is two digits and replaces the last two digits of the cryptocurrency amount, that may mean that amount of cryptocurrency or fiat currency being exchanged is being varied by a negligible amount. Such a negligible amount may be less than a rounding error. If the index value is three digits, four digits, or more, the impact on the total amount of money being exchanged may be greater. As such, to keep the index value small, index values may be assigned based on a temporal component. For example, index values may be assigned for a certain time block, as described above in FIGS. 1-7. Once that time block expires, new index values may be generated. Thus, the transaction component 805 may be configured to reuse index values during different time blocks.

As part of generating the index value, the transaction component 805 may store time block information, the index value, and the transaction information associated with the index value and the time block. This way, the transaction component 805 may be configured to use the index value identified in a received cryptocurrency payment and cross-reference it with the index value information stored by the transaction component 805.

At block 840, the transaction component 805 may modify the cryptocurrency transaction to include the index value. The index value may be incorporated into any digits of the cryptocurrency amount or to any other part of the information in the block chain entry. The transaction component 805 may delete or overwrite information in the cryptocurrency transaction to make room for the index value. In some cases, the transaction component 805 may combine the features of block 830 and 840 and generate a cryptocurrency transaction that includes the index value the first time. In such cases, the cryptocurrency transaction may not be modified, per se, but instead may be generated originally to include the index value.

The transaction component 805 may transmit the cryptocurrency transaction information 845 to the user device 810. The cryptocurrency transaction information 845 may include all of the information associated with the cryptocurrency transaction, in some cases. In other cases, the cryptocurrency transaction information 845 may include the index value and/or the payment address and the user device 810 may be configured to generate the other portions of the cryptocurrency transaction.

At block 850, the user device 810 may output the cryptocurrency transaction to the user. In some cases, the cryptocurrency transaction may be output as a single QR code configured to be scanned by the user, as shown and described with reference to FIG. 3. In some cases, the cryptocurrency transaction may be output as two or more QR codes, as shown and described with reference to FIG. 7. In some cases, the cryptocurrency transaction may be output as information for a text message, as described with reference to FIG. 7. The user device 810 may output multiple types of payments options, including cryptocurrency payment options. In some cases, the user may select which payment option to use, at which time, the user device 810 may then output the cryptocurrency transaction information or other information associated with the selected form of payment.

At block 855, the user device 810 may initiate a cryptocurrency payment over a cryptocurrency exchange 815 using the cryptocurrency transaction information 845. In some cases, the cryptocurrency exchange 815 may be operated by a third-party so that the transaction component 805 may not be capable of interfacing the cryptocurrency exchange 815. In some cases, the cryptocurrency payment may be initiated by a device different from the user device 810. For example, the user device 810 may output a QR code or text messaging information. The user may use a second device (e.g., a mobile phone) to scan the QR code or send a text message using the text messaging information and thereby initiate the cryptocurrency payment based on the cryptocurrency transaction information 845.

The cryptocurrency exchange 815 may send a cryptocurrency payment 860 to the payment address associated with the merchant and the transaction component 805. The cryptocurrency payment 860 may be initiated by the user device 810 or another device associated with a user.

At block 865, the transaction component 805 may verity the cryptocurrency payment and the transaction based on receiving the cryptocurrency payment 860. The transaction component 805 may identify the time the cryptocurrency payment was made by identifying the time the cryptocurrency payment 860 was added to the block chain or by identifying the time the cryptocurrency payment 860 was received. The transaction component 805 may also identify the index value in the cryptocurrency payment 860. For example, the transaction component 805 may identify the values of the digits that are supposed to be the index (e.g., the least significant digits of the cryptocurrency amount).

To link the cryptocurrency payment 860 with the cryptocurrency transaction and/or the transaction information 825, the transaction component 805 may identify one or more candidate time blocks based on the time stamp associated with the cryptocurrency payment 860. For example, the transaction component may determine that the time stamp of the cryptocurrency payment 860 occurs during a first time block. The transaction component 805 may compare the information of the cryptocurrency payment 860 with the stored information associated with the index value found in the cryptocurrency payment 860 and the first time block. If the information matches based on the comparison, the transaction component 805 may link the transaction with the cryptocurrency payment. In some cases, additional verification procedures as described herein may be used as well.

At block 870, the transaction component 805 may perform one or more actions based on verifying the cryptocurrency payment 860. For example, the transaction component 805 may clear an invoice, confirm the payment, cause the goods or services to be provided or shipped, or a combination thereof.

The transaction component 805 may transmit a confirmation 875, which may be an example of an indication, to the user device 810 based on verifying the cryptocurrency payment 860 and/or performing the one or more actions. At block 880, the user device 810 may output the confirmation 875 to complete the transaction.

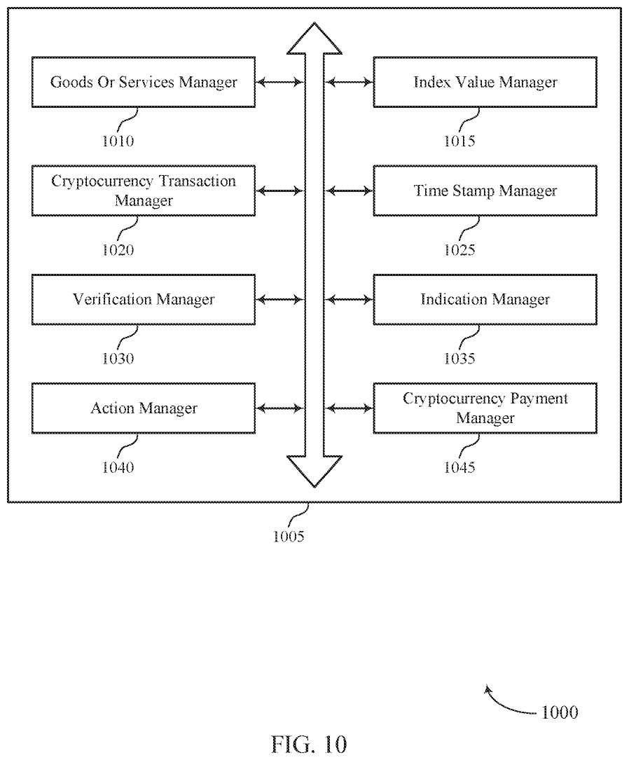

FIG. 9 shows a diagram of a system 900 including a device 905 that supports techniques to link transactions with cryptocurrency transactions in accordance with aspects of the present disclosure. The device 905 may be an example of or include the components of transaction manager as described herein. The device 905 may include components for bi-directional voice and data communications including components for transmitting and receiving communications, including a transaction manager 910, a transceiver 920, an antenna 925, memory 930, a processor 940, and an I/O controller 950. These components may be in electronic communication via one or more buses (e.g., bus 955).

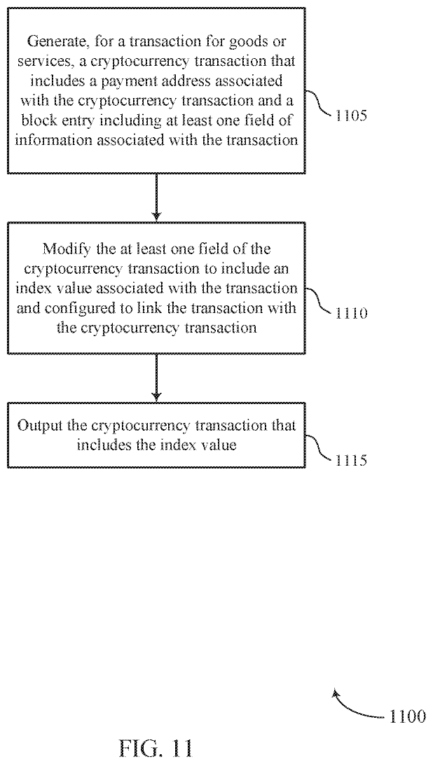

The transaction manager 910 may generate, for a transaction for goods or services, a cryptocurrency transaction that includes a payment address associated with the cryptocurrency transaction and a block entry including at least one field of information associated with the transaction, modify the at least one field of the cryptocurrency transaction to include an index value associated with the transaction and configured to link the transaction with the cryptocurrency transaction, and output the cryptocurrency transaction that includes the index value. The transaction manager 910 may be an example of the transaction manager 1005 described with reference to FIG. 10.

Transceiver 920 may communicate bi-directionally, via one or more antennas, wired, or wireless links. For example, the transceiver 920 may represent a wired transceiver and may communicate bi-directionally with another wired transceiver. The transceiver 920 may also include a modem to modulate the packets and provide the modulated packets to the antennas for transmission, and to demodulate packets received from the antennas. In some cases, the device 905 may include a single antenna 925. However, in some cases the device 905 may have more than one antenna 925, which may be capable of concurrently transmitting or receiving multiple wireless transmissions.

The memory 930 may include random access memory (RAM), read-only memory (ROM), or a combination thereof. The memory 930 may store computer-readable code 935 including instructions that, when executed by a processor (e.g., the processor 940) cause the device to perform various functions described herein. In some cases, the memory 930 may contain, among other things, a basic input/output system (BIOS) which may control basic hardware or software operation such as the interaction with peripheral components or devices.

The processor 940 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques to link transactions with cryptocurrency transactions).

The I/O controller 950 may manage input and output signals for the device 905. The I/O controller 950 may also manage peripherals not integrated into the device 905. In some cases, the I/O controller 950 may represent a physical connection or port to an external peripheral. In some cases, the I/O controller 950 may utilize an operating system such as iOS®, ANDROID®, MS-DOS®, MS-WINDOWS®, OS/2®, UNIX®, LINUX®, or another known operating system. In other cases, the I/O controller 950 may represent or interact with a modem, a keyboard, a mouse, a touchscreen, or a similar device. In some cases, the I/O controller 950 may be implemented as part of a processor. In some cases, a user may interact with the device 905 via the I/O controller 950 or via hardware components controlled by the I/O controller 950.

The code 935 may include instructions to implement aspects of the present disclosure, including instructions to support cryptocurrency transactions. The code 935 may be stored in a non-transitory computer-readable medium such as system memory or other type of memory. In some cases, the code 935 may not be directly executable by the processor 940 but may cause a computer (e.g., when compiled and executed) to perform functions described herein.

FIG. 10 shows a block diagram 1000 of a transaction manager 1005 that supports techniques to link transactions with cryptocurrency transactions in accordance with aspects of the present disclosure. The transaction manager 1005 may be part of a device (e.g., device 905) that supports techniques to link transactions with cryptocurrency transactions in accordance with aspects of the present disclosure. The device may be an example of aspects of transaction components as described herein. The transaction manager 1005 may be an example of the transaction manager 910 described with reference to FIG. 9.

The transaction manager 1005 may generate, for a transaction for goods or services, a cryptocurrency transaction that includes a payment address associated with the cryptocurrency transaction and a block entry including at least one field of information associated with the transaction, modify the at least one field of the cryptocurrency transaction to include an index value associated with the transaction and configured to link the transaction with the cryptocurrency transaction, and output the cryptocurrency transaction that includes the index value.

The transaction manager 1005, or its sub-components, may be implemented in hardware, code (e.g., software or firmware) executed by a processor, or any combination thereof. If implemented in code executed by a processor, the functions of the transaction manager 1005, or its sub-components may be executed by a general-purpose processor, a digital signal processor (DSP), an application-specific integrated circuit (ASIC), a field programmable gate array (FPGA), or other programmable logic device, discrete gate or transistor logic, discrete hardware components, or any combination thereof designed to perform the functions described in the present disclosure.

The transaction manager 1005, or its sub-components, may be physically located at various positions, including being distributed such that portions of functions are implemented at different physical locations by one or more physical components. In some examples, the transaction manager 1005, or its sub-components, may be a separate and distinct component in accordance with various aspects of the present disclosure. In some examples, the transaction manager 1005, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transaction manager 1005 may include a goods or services manager 1010, an index value manager 1015, a cryptocurrency transaction manager 1020, a time stamp manager 1025, a verification manager 1030, an indication manager 1035, an action manager 1040, and a cryptocurrency payment manager 1045. Each of these modules may communicate, directly or indirectly, with one another (e.g., via one or more buses).

The goods or services manager 1010 may generate, for a transaction for goods or services, a cryptocurrency transaction that includes a payment address associated with the cryptocurrency transaction and a block entry including at least one field of information associated with the transaction.

The index value manager 1015 may modify the at least one field of the cryptocurrency transaction to include an index value associated with the transaction and configured to link the transaction with the cryptocurrency transaction. In some examples, the index value manager 1015 may identify the index value included in the at least one field associated with the received cryptocurrency payment where the at least one field is a blockchain entry. In some examples, the index value manager 1015 may identify a time block associated with generating the cryptocurrency transaction.

In some examples, the index value manager 1015 may generate the index value based on identifying the time block associated with the cryptocurrency transaction, where modifying the cryptocurrency transaction is based on generating the index value. In some examples, the index value manager 1015 may replace at least one digit that indicates the amount of cryptocurrency exchanged with the index value, where modifying the at least one field of the cryptocurrency transaction is based on replaying the at least one digit.

The cryptocurrency transaction manager 1020 may output the cryptocurrency transaction that includes the index value. In some examples, the cryptocurrency transaction manager 1020 may output the cryptocurrency transaction includes outputting the cryptocurrency transaction over a text messaging system. In some cases, the code includes a QR code. In some cases, the code includes a first QR code that includes the payment address for the cryptocurrency transaction, and a second OR code that includes at least one transaction detail for the transaction. In some cases, the at least one field of the cryptocurrency transaction indicates an amount of cryptocurrency exchanged. In some cases, the index value replaces one or more digits of the amount of cryptocurrency exchanged. In some cases, the one or more digits replaced with the index value includes a satoshi amount digit of the amount of cryptocurrency exchanged.

The time stamp manager 1025 may identify a time stamp associated with a cryptocurrency payment received based on outputting the cryptocurrency transaction.

The verification manager 1030 may verify that the received cryptocurrency payment is the cryptocurrency transaction associated with the transaction based on identifying the index value. In some examples, the verification manager 1030 may verify that the received cryptocurrency payment is the cryptocurrency transaction based on matching the index value associated with the time block with the index value in the received cryptocurrency payment.

In some examples, the verification manager 1030 may verify that the received cryptocurrency payment is the cryptocurrency transaction based on matching the index value of an earlier time block to the index value in the received cryptocurrency payment, matching the received cryptocurrency payment to the cryptocurrency transaction outputted during the earlier time block, or matching at least two fields of the received cryptocurrency payment to those of the cryptocurrency transaction of the earlier time block, or combinations thereof.

In some examples, the verification manager 1030 may identify a time block associated with determining the index value. In some examples, the verification manager 1030 may determine the index value based on identifying the time block, where modifying the at least one field of the cryptocurrency transaction is based on determining the index value. In some cases, the time block is associated with scanning a code posted when generating the transaction.

The indication manager 1035 may output an indication that the cryptocurrency payment is received based on verifying that the received cryptocurrency payment is the cryptocurrency transaction.

The action manager 1040 may clear an invoice associated with the transaction based on verifying that the received cryptocurrency payment is the cryptocurrency transaction. In some examples, the action manager 1040 may confirm that the index value in the at least one field and the time stamp matches a time block associated with the generation of the index value, where verifying that the received cryptocurrency payment is the cryptocurrency transaction is based on the confirmation.

The cryptocurrency payment manager 1045 may receive a cryptocurrency payment associated with the index value based on outputting the cryptocurrency transaction.

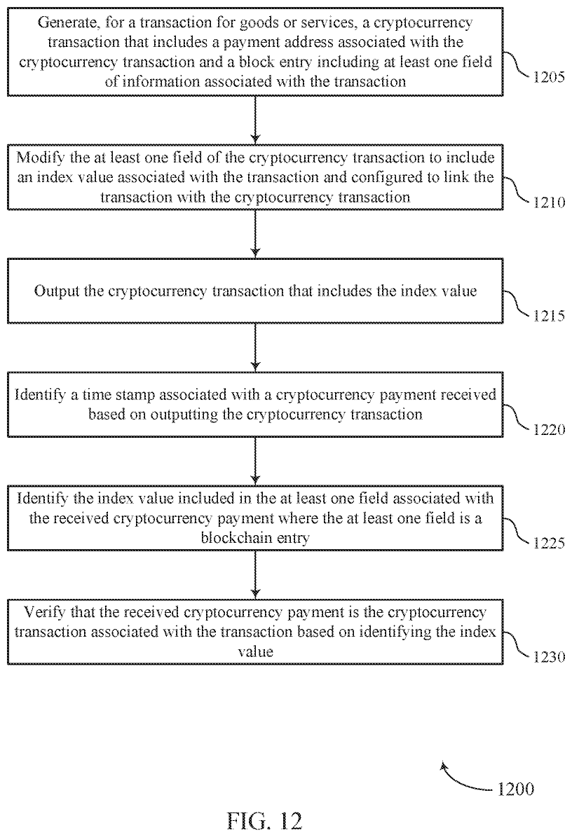

FIG. 11 shows a flowchart illustrating a method 1100 that supports techniques to link transactions with cryptocurrency transactions in accordance with aspects of the present disclosure. The operations of method 1100 may be implemented by a transaction component 115, device 905, or their components as described herein. For example, the operations of method 1100 may be performed by a transaction component as described with reference to FIGS. 1-10. In some examples, a transaction component may execute a set of instructions to perform the functions described below. Additionally or alternatively, a transaction component may perform aspects of the functions described below using special-purpose hardware.

At 1105, the transaction component may generate, for a transaction for goods or services, a cryptocurrency transaction that includes a payment address associated with the cryptocurrency transaction and a block entry including at least one field of information associated with the transaction. The operations of 1105 may be performed according to the methods described herein. In some examples, aspects of the operations of 1105 may be performed by a goods or services manager as described with reference to FIG. 10.

At 1110, the transaction component may modify the at least one field of the cryptocurrency transaction to include an index value associated with the transaction and configured to link the transaction with the cryptocurrency transaction. The operations of 1110 may be performed according to the methods described herein. In some examples, aspects of the operations of 1110 may be performed by an index value manager as described with reference to FIG. 10.

At 1115, the transaction component may output the cryptocurrency transaction that includes the index value. The operations of 1115 may be performed according to the methods described herein. In some examples, aspects of the operations of 1115 may be performed by a cryptocurrency transaction manager as described with reference to FIG. 10.

FIG. 12 shows a flowchart illustrating a method 1200 that supports techniques to link transactions with cryptocurrency transactions in accordance with aspects of the present disclosure. The operations of method 1200 may be implemented by a transaction component 115, device 905, or their components as described herein. For example, the operations of method 1200 may be performed by a transaction component as described with reference to FIGS. 1-10. In some examples, a transaction component may execute a set of instructions to perform the functions described below. Additionally or alternatively, a transaction component may perform aspects of the functions described below using special-purpose hardware.

At 1205, the transaction component may generate, for a transaction for goods or services, a cryptocurrency transaction that includes a payment address associated with the cryptocurrency transaction and a block entry including at least one field of information associated with the transaction. The operations of 1205 may be performed according to the methods described herein. In some examples, aspects of the operations of 1205 may be performed by a goods or services manager as described with reference to FIG. 10.

At 1210, the transaction component may modify the at least one field of the cryptocurrency transaction to include an index value associated with the transaction and configured to link the transaction with the cryptocurrency transaction. The operations of 1210 may be performed according to the methods described herein. In some examples, aspects of the operations of 1210 may be performed by an index value manager as described with reference to FIG. 10.

At 1215, the transaction component may output the cryptocurrency transaction that includes the index value. The operations of 1215 may be performed according to the methods described herein. In some examples, aspects of the operations of 1215 may be performed by a cryptocurrency transaction manager as described with reference to FIG. 10.

At 1220, the transaction component may identify a time stamp associated with a cryptocurrency payment received based on outputting the cryptocurrency transaction. The operations of 1220 may be performed according to the methods described herein. In some examples, aspects of the operations of 1220 may be performed by a time stamp manager as described with reference to FIG. 10.

At 1225, the transaction component may identify the index value included in the at least one field associated with the received cryptocurrency payment where the at least one field is a blockchain entry. The operations of 1225 may be performed according to the methods described herein. In some examples, aspects of the operations of 1225 may be performed by an index value manager as described with reference to FIG. 10.

At 1230, the transaction component may verify that the received cryptocurrency payment is the cryptocurrency transaction associated with the transaction based on identifying the index value. The operations of 1230 may be performed according to the methods described herein. In some examples, aspects of the operations of 1230 may be performed by a verification manager as described with reference to FIG. 10.

It should be noted that the methods described herein describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for cryptocurrency transactions, comprising:
generating, for a transaction for goods or services, a cryptocurrency transaction that includes a payment address associated with the cryptocurrency transaction and a block entry comprising at least one field of information associated with the transaction;
modifying the at least one field of the cryptocurrency transaction to include an index value associated with the transaction and configured to link the transaction with the cryptocurrency transaction; and
outputting the cryptocurrency transaction that includes the index value.

2. The method of claim 1, further comprising:
identifying a time stamp associated with a cryptocurrency payment received based at least in part on outputting the cryptocurrency transaction;
identifying the index value included in the at least one field associated with the received cryptocurrency payment wherein the at least one field is a blockchain entry; and
verifying that the received cryptocurrency payment is the cryptocurrency transaction associated with the transaction based at least in part on identifying the index value.

3. The method of claim 2, further comprising:
outputting an indication that the cryptocurrency payment is received based at least in part on verifying that the received cryptocurrency payment is the cryptocurrency transaction.

4. The method of claim 2, further comprising:
clearing an invoice associated with the transaction based at least in part on verifying that the received cryptocurrency payment is the cryptocurrency transaction.

5. The method of claim 2, further comprising:
confirming that the index value in the at least one field and the time stamp matches a time block associated with the generation of the index value, wherein verifying that the received cryptocurrency payment is the cryptocurrency transaction is based at least in part on the confirmation.

6. The method of claim 1, further comprising:
identifying a time block associated with generating the cryptocurrency transaction;
generating the index value based at least in part on identifying the time block associated with the cryptocurrency transaction, wherein modifying the cryptocurrency transaction is based at least in part on generating the index value; and
receiving a cryptocurrency payment associated with the index value based at least in part on outputting the cryptocurrency transaction.

7. The method of claim 6, further comprising:
verifying that the received cryptocurrency payment is the cryptocurrency transaction based at least in part on matching the index value associated with the time block with the index value in the received cryptocurrency payment.

8. The method of claim 6, further comprising:
verifying that the received cryptocurrency payment is the cryptocurrency transaction based at least in part on matching the index value of an earlier time block to the index value in the received cryptocurrency payment, matching the received cryptocurrency payment to the cryptocurrency transaction outputted during the earlier time block, or matching at least two fields of the received cryptocurrency payment to those of the cryptocurrency transaction of the earlier time block, or combinations thereof.

9. The method of claim 1, further comprising:
identifying a time block associated with determining the index value; and
determining the index value based at least in part on identifying the time block, wherein modifying the at least one field of the cryptocurrency transaction is based at least in part on determining the index value.

10. The method of claim 9, wherein the time block is associated with scanning a code posted when generating the transaction.

11. The method of claim 10, wherein the code comprises a QR code.

12. The method of claim 11, wherein the code comprises a first QR code that includes the payment address for the cryptocurrency transaction, and a second OR code that includes at least one transaction detail for the transaction.

13. The method of claim 1, wherein:
the at least one field of the cryptocurrency transaction indicates an amount of cryptocurrency exchanged; and
the index value replaces one or more digits of the amount of cryptocurrency exchanged.

14. The method of claim 13, wherein the one or more digits replaced with the index value includes a satoshi amount digit of the amount of cryptocurrency exchanged.

15. The method of claim 13, further comprising:
replacing at least one digit that indicates the amount of cryptocurrency exchanged with the index value, wherein modifying the at least one field of the cryptocurrency transaction is based at least in part on replaying the at least one digit.

16. The method of claim 1, wherein:
outputting the cryptocurrency transaction includes outputting the cryptocurrency transaction over a text messaging system.

17. An apparatus for cryptocurrency transactions, comprising:
a processor,
memory in electronic communication with the processor; and
instructions stored in the memory and executable by the processor to cause the apparatus to:
generate, for a transaction for goods or services, a cryptocurrency transaction that includes a payment address associated with the cryptocurrency transaction and a block entry comprising at least one field of information associated with the transaction;
modify the at least one field of the cryptocurrency transaction to include an index value associated with the transaction and configured to link the transaction with the cryptocurrency transaction; and
output the cryptocurrency transaction that includes the index value.

18. The apparatus of claim 17, wherein the instructions are further executable by the processor to cause the apparatus to:
identify a time stamp associated with a cryptocurrency payment received based at least in part on outputting the cryptocurrency transaction;
identify the index value included in the at least one field associated with the received cryptocurrency payment wherein the at least one field is a blockchain entry; and
verify that the received cryptocurrency payment is the cryptocurrency transaction associated with the transaction based at least in part on identifying the index value.

19. A non-transitory computer-readable medium storing code for cryptocurrency transactions, the code comprising instructions executable by a processor to:
generate, for a transaction for goods or services, a cryptocurrency transaction that includes a payment address associated with the cryptocurrency transaction and a block entry comprising at least one field of information associated with the transaction;
modify the at least one field of the cryptocurrency transaction to include an index value associated with the transaction and configured to link the transaction with the cryptocurrency transaction; and
output the cryptocurrency transaction that includes the index value.

20. The non-transitory computer-readable medium of claim 19, wherein the code further comprises instructions executable by the processor to:
identify a time stamp associated with a cryptocurrency payment received based at least in part on outputting the cryptocurrency transaction;
identify the index value included in the at least one field associated with the received cryptocurrency payment wherein the at least one field is a blockchain entry; and
verify that the received cryptocurrency payment is the cryptocurrency transaction associated with the transaction based at least in part on identifying the index value.
